(19) United States
(12) Patent Application Publication
(10) Pub. No.: US 2006/0245906 A1
(43) Pub. Date: Nov. 2, 2006

(54) Device for accommodating disk-shaped objects and apparatus for handling objects

(76) Inventors: Arthur Pelzmann, Gunzburg (DE); Martin Drechsler, Memmingen (DE); Jurgen Niess, Sontheim (DE); Michael Grandy, Senden (DE); Hin Yiu Chung, Elchingen (DE); Paul Mantz, Ehingen (DE); Ottmar Graf, Bergatreute (DE)

Correspondence Address: DORITY & MANNING, P.A., POST OFFICE BOX 1449, GREENVILLE, SC, 29602-1449, US

(21) Appl. No.: 11/333,727

(22) Filed: Jan. 17, 2006

Related U.S. Application Data
(63) Continuation of application No. 10/478,285, filed on Nov. 18, 2003.

(30) Foreign Application Priority Data
May 18, 2001 (DE) 101 24 647.1
Nov. 16, 2001 (DE) 101 56 441.4

(51) Int. Cl. B66C 23/00

(52) U.S. Cl. 414/744.8

(57) ABSTRACT

A device is provided for accommodating disk-shaped objects, preferably semiconductor wafers for a thermal treatment thereof. The device has a carrier with at least two recesses for respective objects, and at least one cover for covering at least one of the recesses. A handling apparatus is also provided and has at least one transport arm, at least one support arm, at least one support drive provided on the arm for supporting, via vacuum, at least one object that is to be handled, a device for determining the individual weight of an object, and a vacuum control device for altering the vacuum as a function of the individual weight of an object.

### RELATED APPLICATIONS

The present application is a continuation application of U.S. patent application Ser. No. 10/478,285 filed on Nov. 18, 2003 and based on PCT/EP02/04790 filed May 2, 2002 and German priority documents 101 24 647.1 filed 18 May 2001 and 101 56 441.4 filed 16 Nov. 2001.

### BACKGROUND OF THE INVENTION

The present invention relates to a device for accommodating disk-shaped objects, preferably semiconductor wafers, for the thermal treatment thereof. The invention also relates to a handling apparatus for objects.

For the industrial manufacture of electronic components, semiconductor materials having a disk-shaped configuration, so called wafers, are subjected to thermal treatments. Especially the thermal processing of objects, such as wafers, by means of rapid heating units, also known as RTP units (Rapid Thermal Processing) is continuously being emphasized. The main advantage of RTP units is their high throughput, which is based upon the possibility of being able to very rapidly heat up the wafers. Heating rates of up to 300° C./s can be achieved in RTP units.

An RTP unit essentially comprises a transparent process chamber in which a wafer that is to be processed can be disposed upon suitable support devices. Furthermore, in addition to the wafer, diverse auxiliary elements, such as, for example, a light-absorbing plate, a compensation ring that spans the wafer, or a rotation or tilting device for the wafer can be disposed in the process chamber. The process chamber can be provided with suitable gas inlets and outlets in order to be able to produce a prescribed atmosphere within the process chamber in which the wafer is to be processed. The wafer is heated by a thermal radiation that issues from a heating device that can be disposed either above the wafer or below the wafer or on both sides, and is composed of a plurality of lamps, rod or point-type lamps, or a combination thereof. The overall arrangement can be surrounded by an external chamber, the inner walls of which are entirely or at least partially reflective.

In alternative RTP units, the wafer is placed upon a heating plate or susceptor, and is heated by a thermal contact with this susceptor.

With connecting or combination semiconductors, such as Ill-V or II-IV semiconductors, such as, for example, GaN, InP, GaAs or tertiary compounds such as, for example, InGaAs or quaternary compounds such as InGaAsP, there is, however, the problem that generally one component of the semiconductor is volatile and upon heating of the wafer evaporates out of the wafer. There results predominantly in the edge region of such wafers a heating zone with a reduced concentration of the evaporated-out component. The result is an alteration of the physical characteristics, such as, for example, the electrical conductivity, of the wafer in this region, which can make the wafer unusable for the production of electrical components.

From the two publications U.S. Pat. No. 5,872,889 A and U.S. Pat. No. 5,837,555 A, which originate with the applicant, it is known to dispose wafers of combination semiconductors in a closed receptacle of graphite for the thermal treatment. Due to its stability at high temperatures, graphite is particularly suitable for such receptacles. The wafer is placed upon a support that has a recess for accommodating the wafer. Placed over the recess is a lid-like cover, so that a closed space results in which the wafer is disposed. This graphite receptacle in which the wafer is contained is subjected to a thermal treatment in the process chamber of an RTP unit. In this way, a diffusing-out of a component of the combination semiconductor is suppressed, and the wafer can be safely processed.

The described graphite receptacle is predominantly used for processing wafers of a combination semiconductor having diameters of 200 mm and 300 mm. However, very common are also wafers of combination semiconductors having small diameters of 50 mm, 100 mm, or 150 mm.

It is an object of the present invention to provide a device with which wafers of combination semiconductors can be safely processed in a simple manner and at high productivity.

### SUMMARY OF THE INVENTION

Pursuant to the invention, this object is realized by a carrier having at least two recesses for respectively receiving a wafer. With such carriers, a plurality of wafers can be processed simultaneously. In contrast to the known treatment methods, this means a considerable increase of the throughput of an RTP unit, and represents a significant economical advantage.

Pursuant to one particularly advantageous embodiment, the inventive device has at least one cover for covering at least one recess in order to provide an essentially closed-off space about the objects.

For example, a single large cover is possible that covers all of the recesses of the carrier with the wafers contained therein. However, alternatively each recess could also be covered by individual covers. It is also possible that one of the covers simultaneously covers any desired number of recesses, although more than one and not all of them, or any desired number of the recesses can be individually covered and the remainder of the recesses can remain uncovered. Such a cover can be combined in any desired manner with other similar covers as well as with individual covers for a respective recess and with non-covered recesses.

The carrier that is provided with the recesses is preferably made of graphite, sapphire, quartz, boron nitride, aluminum nitride, silicon, silicon carbide, silicon nitride, ceramic or metal. Similarly, at least one of the covers can be made of graphite or sapphire or quartz or boron nitride or aluminum nitride or silicon or silicon carbide or silicon nitride or ceramic or metal. However, not only the carrier but also at least one or all of the covers can also be made of the aforementioned materials.

For RTP processes, advantageously carriers are used having at least one cover that has a low specific thermal capacity, preferably 0.2 to 0.8 J/gK, of the carrier and/or of at least one cover. For this reason, the carrier should have as low a thickness as possible.

Similarly, carriers having at least one cover are advantageous where the carrier and/or at least one of the covers has a high thermal conductivity, preferably 10 to 100 W/mK.

At least parts of the carrier, or parts of one of the covers, or parts of the carrier and parts of one of the covers, are preferably coated. For example, it can be advantageous to at least partially provide an inner surface of one or of all of the recesses, as well as a surface that covers the recess of one or more of the covers, with a coating that is inert to chemical processes that take place within the covered recesses during the processing of the wafer, whereas external surfaces of the carrier remain uncoated in order to have desired absorption characteristics relative to the thermal radiation. In other cases, for example local optical characteristics of carrier and covers can be achieved by suitable area wise coatings of the outer surfaces.

Similarly, it can be advantageous to make at least parts of the carrier, or parts of at least one of the covers or parts of the carrier and parts of at least one of the covers, transparent for the thermal radiation by making them, for example, of quartz or sapphire. The covers, as well as parts of the carrier that correspond to the base surfaces of the recesses, are advantageously nontransparent for the thermal radiation, while the other parts of the carrier are transparent.

It is furthermore possible to produce predetermined atmospheres within covered recesses. Depending upon the type of wafer that is to be processed, a different atmosphere can exist in each covered recess. For example, if in at least one first recess a InP wafer is processed, a phosphorous-containing atmosphere exists in the recess. In at least one second recess in which a GaAs wafer is to be processed, an arsenic-containing atmosphere exists. Finally, in at least one third, optionally not covered recess a wafer can be processed that comprises silicon, in other words not a combination semiconductor.

At least some of the wafers accommodated by the carrier can be at least partially coated. However, the volume material of at least one of the wafers can also vary in zones in that the wafer is provided, for example, with an implanted layer.

The inventive carrier for a plurality of wafers, which are subjected to a thermal treatment in common in a process chamber, makes it possible during the same process stage to achieve different process results with the same course of the thermal radiation for each wafer. Depending upon the coating or transparency of local regions of the carrier and/or of the corresponding cover, locally different optical conditions can be achieved that lead to different temperatures in the interior of the covered recesses. Thus, each wafer experiences an individual process temperature, although the course of the thermal radiation is the same for all wafers. Thus, with one processing stage it is possible not only to simultaneously treat a plurality of wafers, but in so doing the wafers can even be subjected to different processes. This means that wafers of different materials can be treated simultaneously.

The recesses in the carrier preferably have the same depth, so that after loading of the carrier the wafers are all disposed parallel and in the same plane.

However, it can also be advantageous to vary the depths of the recesses. In this case, although the wafers are always disposed parallel to one another, they are offset with respect to height and are disposed at different planes.

For cylindrical recesses having flat horizontal bases, the wafers rest flat on the base of the recess.

A support of the wafers within at least one recess is advantageously selected, whereby a contact between wafer and the base of the recess is avoided. This is advantageously achieved by pin-shaped support elements that are disposed in the recess and which accommodate the wafer. With the same depth of the recesses but different lengths of the support elements, the wafers can then be disposed at planes of different heights.

Another preferred possibility of arranging the wafers such that a contact with the base of the recess is avoided is to support the rim portion of the wafer. This is achieved by making at least one recess so that it tapers conically inwardly. In this way, an inwardly beveled edge of the recess is obtained that leads to a rim support of a wafer. Pursuant to another embodiment, at least one recess has a concave configuration that again leads to supporting the rim of the wafer on the edge of the recess. Depending upon the design of the conical and of the concave recesses, the wafer can be placed at different heights.

To load the carrier, the wafers are advantageously sequentially placed via a gripper directly into the recesses or onto support pins. Suitable for this purpose are grippers having suction devices that draw the wafers against them. This can be effected via a suction device that operates according to the Bernoulli principle.

Support pins are advantageously provided for the loading of the carrier and preferably extend through the carrier. These support pins advantageously have different heights for different recesses in order not to obstruct a loading of the recesses that are remote from the gripper by the support pins that are provided for loading the recesses that face the gripper.

Similarly, the covers can be placed upon support pins that either extend through the carrier or are disposed entirely externally of the carrier. The support pins for the covers are advantageously longer than the support pins for the wafers.

The support pins and the carrier are preferably vertically movable relative to one another.

As soon as the wafers are placed upon the support pins, the support pins move downwardly through the carrier, as a result of which the wafers are raised from the support pins and are deposited in the recesses associated with them. Alternatively, the carrier could also be moved upwardly.

Another preferred method for loading the carrier sequentially rotates the carrier about a vertical axis in order to respectively rotate the recess that is to be loaded to the gripper.

As soon as the carrier is loaded with the wafers, the corresponding covers can either be placed directly upon the carrier or upon support pins by the gripper if they were not already placed upon appropriate support pins prior to the wafers.

A loading of the carrier is preferably effected within the process chamber. However, it can also be loaded externally of the process chamber and can subsequently be introduced into the process chamber for the thermal treatment.

A plurality of such carriers with covers can, for example, advantageously be stacked one above or next to each other within a process chamber for a thermal treatment.

The loading and unloading of the carrier with the substrates and/or covers is preferably effected with an automatic loading and unloading unit which can be appropriately controlled in correspondence to the loading and unloading processes.

The inventive device is preferably, although not exclusively, particularly suitable for wafers of combination semiconductors having predominantly small diameters. The thermal treatment of the semiconductor wafers is preferably effected in RTP units in which prescribed environmental conditions and temperature profiles can be set. In this connection, during the treatment the carrier is extensively stable at the environmental conditions and the temperatures.

Semiconductor wafers, especially combination semiconductor wafers, as they were previously described, are relatively thin and have thicknesses of 50 to 500 μm, and customarily 200 μm. These wafers are therefore very susceptible to breakage during the handling, so that with the conventional handling by hand or with handling apparatus, such as robots and the like, breakage of the wafers frequently occurs, thus considerably reducing the yield during the manufacture of the semiconductors. Especially with semiconductor wafers that are used for expensive components, such as, for example, laser diodes, this is particularly evident, since a two-inch wafer for this purpose has a value in the range of [symbol] 25,000.

As already indicated previously, the wafers are treated in receptacles that are made, for example, of graphite and are introduced into a process chamber for the treatment of the wafers. These so-called graphite boxes have a weight of 200 to 2,000 g, depending upon the number and the size of the wafers that are to be accommodated in the boxes.

Not only the wafers but also the receptacles themselves are manually handled with such units, since with conventional handling apparatus it is not possible on the one hand to handle the very thin semiconductor wafers that have a weight in the range of 0.1 to 20 g, and on the other hand to handle the receptacles that in contrast are heavy, without having a high reject rate due to breakage of wafers.

It is therefore furthermore an object of the present invention to provide a handling apparatus with which objects having different weights can be securely and reliably handled.

Pursuant to the invention, the stated object is realized with a handling apparatus having at least one transport arm, which in turn has at least one support device for supporting, via vacuum, at least one object that is to be handled, by a vacuum control device for altering the vacuum as a function of the weight of the object.

Due to the inventive feature of providing a vacuum control device via which the vacuum of support devices on the transport arms can be set, controlled or regulated as a function of the weight of the object, it is now possible to transport and handle, with one and the same handling apparatus, objects having very different weights. For example, with the inventive handling apparatus it is possible to undertake the handling and the transport of wafers and wafer receptacles while avoiding manual handling, and in particular in such a way that on the one hand, for example, relatively heavy receptacles can be handled with the same handling apparatus as are the very thin, breakable wafers having a low weight while avoiding breakage of the wafers. The inventive handling apparatus thus enables, for example, not only the loading and unloading of receptacles into or out of the process chamber, but also the loading and unloading of the thin, breakable wafers into and out of the receptacle. Aside from the fact that in so doing the possibility of a complete automation of the processing of semiconductor wafers, especially also in conjunction with thermal treatments, is provided, this takes place with a single handling apparatus, so that equipment costs can thereby be kept low. With the process automation that has become possible with the inventive handling apparatus, the production yield is significantly increased since breakage of wafers, as frequently occurs during manual loading and unloading of the receptacle and of the process chamber, is avoided or at least significantly reduced. A treatment unit having the inventive handling apparatus is therefore amortized considerably earlier than are conventional treatment units due to the low rejection rate and the rapid and reliable handling, especially if the unit is used for manufacturing very expensive components.

Pursuant to one preferred embodiment of the invention, the vacuum control device includes only one vacuum source and vacuum change-over devices, for example line change-over switches, for switching between a line with and without a vacuum regulator. In this way, only one vacuum source is required, whereby the vacuum regulator is preferably an adjustable valve. Pursuant to an alternative embodiment, at least two separately controllable vacuum systems are provided.

Pursuant to one advantageous embodiment of the invention, the pressure ratio for the objects that are to be handled and that have different weights is in a range of from 10 to 10,000. This vacuum ratio is essentially a function of the weight ratio of the objects that are to be handled and also of the design of the support devices.

Pursuant to a very advantageous embodiment of the invention, an object having a low weight is a silicon semiconductor wafer, and an object having a greater weight is a receptacle in which the wafers are disposed during at least one treatment step. Receptacles of this type have been described previously by way of example.

Although the support devices for objects having different weights can be embodied in the same manner, it is, however, advantageous pursuant to a further embodiment of the invention to also embody the support devices differently for the different objects, especially for objects having different weights. The support devices are preferably so-called pads or support cushions that are connected via a line with a vacuum source or a vacuum system. The individual support devices or pads can be supplied with the same vacuum, or they can also be supplied with respectively different vacuums, which in this case, however, requires appropriate control elements, such as, for example, valves or separate vacuum systems.

In this connection, the support devices are preferably adapted to the objects having different weights, for example also to the shape and surface structure of the objects. For example, for supporting the receptacle generally larger support surfaces are required than for supporting the light wafers. For example, it is advantageous for wafers to select the diameter of the support devices or pads to be approximately 3 mm, or the surface upon which the vacuum acts per pad to be approximately 0.1 cm². The shape of the pads is to be selected in conformity with the prescribed requirements, and it can be round or rectangular or have some other configuration. However, the pads are preferably round, since here the ratio surface/rim is the greatest, and in so doing even at a low suction power of the vacuum source a reliable holding of the object, for example the wafer, is ensured.

So that a wafer having a weight of, for example, 0.1 g to 0.5 g can be reliably held, the contact pressure produced by the pads, and via which the wafer is pressed against the support, must be great enough that the frictional force resulting from the contact pressure is greater than the forces produced by acceleration of the transport arm or the acceleration due to gravity, which act upon the object, for example the wafer. With wafers this is achieved, for example, via a vacuum of approximately 0.005 bar (this corresponds to an absolute pressure of 0.995 bar), if the (horizontal) acceleration forces acting upon the wafer are less than 1 g. In this connection, one must take into account the frictional coefficient between wafer and support, which can again be a function of wafer temperatures.

If the vacuum is greater, i.e. the absolute pressure smaller, the wafer will still always be reliably held, in other words, the acceleration force can exceed 1 g, although there then exists the danger of wafer breakage.

In general, the pad pressure that is to be selected is to be adapted to the maximum acceleration that occurs, as a result of which it is advantageous if the pressure is preferably controllable or regulatable. A vacuum that is too great is to be avoided. The adaptation of pressure can be effected not only prior to the start of the movement sequence but also during the movement itself. The maximum permissible acceleration of the wafer is a function of the thickness of the wafer and its diameter, the material and the type of wafer surface in the support region, in other words, also whether or not a structured or unstructured support region is provided.

If wafers having unstructured support regions are handled, an arrangement of the pads at approximately ⅔ of the wafer radius-relative to the center of the wafer-is preferably selected. In this way, the wafer is supported in a manner that is as free of stress as possible. With structured support regions, the pads preferably support the rim region of the wafer.

The inventive handling apparatus is preferably provided with a three-point support device for the object having greater weight and/or for the object with lesser weight.

As already indicated, in this connection the support devices for the different objects, and in particular those having different weights, preferably have different configurations.

The support devices for the objects that in particular differ with regard to their weight can both be disposed on one side of the transport arm. Pursuant to a particularly advantageous embodiment of the invention, however, support devices are provided on both sides of the transport arm. This makes it possible to hold the objects that are to be handled during the handling process on the upper side or on the underside of the transport arm depending upon the given conditions. Pursuant to a further embodiment of the invention, it is particularly advantageous if there is provided on one side of the transport arm support devices for the heavier object and on the other side support devices for the lighter object. The one side, for example the upper side, has a first support or pad structure or support surface structure, for example for supporting receptacles, while on the underside of the transport arm there is provided a second support or pad structure, for example for supporting the wafer. For example, the wafer is held from below and the receptacle from above, or vise versa. With such an embodiment of the inventive handling apparatus, it is also possible to eliminate a vacuum control and to operate both support devices with the same vacuum, since the holding forces are determined or codetermined by the differing pad structures, especially the differing surface conditions. In addition, the frictional coefficients of the support surfaces can differ from above and below.

Pursuant to a further very advantageous embodiment of the invention, the transport arm is rotatable by 180° relative to its longitudinal axis.

As a result, the side with the support device adapted to a corresponding object can be rotated upwardly or downwardly.

Pursuant to a further embodiment of the invention, at least two transport arms are provided, of which at least one is provided for supporting a heavier object and at least one further one is provided for supporting a lighter weight object. In this way, the support devices are respectively provided on their own transport arm separately from one another for the respective different objects.

Pursuant to a further advantageous embodiment of the invention, the vacuum control device can be controlled as a function of a prescribed program sequence. Alternatively or in addition to this possibility, it is particularly advantageous if a sensor, for example a wire strain gauge, is provided for measuring the weight of the object that is to be handled. The result of this weight measurement, in other words the output signal of the sensor, is subsequently utilized for controlling the vacuum control device. In this connection, the sensor can be provided directly on the transport arm or it is, however, also possible to first slightly raise the object, the weight of which is to be determined, whereby the support pressure for supporting the object is determined as a measure for the weight of the object. By determining its individual weight, the object is reliably held during the movement. With this individual support pressure, the object is then moved. In addition to the actual support pressure, it is also possible to select or set the maximum acceleration, a selection of a previously fixed trajectory of the object, the speed or some other movement parameter. In this way, it is also possible to control so-called edge grippers that grasp the rim of the object, for example a wafer or a box, and fix the object at the rim in order to achieve a localized fixing of the object in position relative to the handling apparatus. Such a firm holding can be effected, for example, mechanically, wherein the term “holding pressure” is also to be understood to mean a mechanical contact pressure of mechanical parts of the handling apparatus against the object.

### BRIEF DESCRIPTION OF THE DRAWINGS

The present invention will be explained in greater detail subsequently with the aid of preferred embodiments of the invention in conjunction with the drawings, in which:

FIG. 1 is a schematic cross-sectional illustration through a rapid heating unit;

FIGS. 2a) and 2b) show a carrier for accommodating up to seven wafers, in plan and in cross-section along the section line indicated in FIG. 2a);

FIG. 3a) to 3f) show various embodiments of the cover of recesses in the carrier;

FIG. 4 shows two illustrations of alternative combinations of recess with wafer and cover;

FIG. 5 shows various embodiments for recesses;

FIG. 6 shows a mechanism for the loading and unloading of the carrier;

FIG. 7 shows a schematic illustration of a transport arm of an inventive handling apparatus in plan;

FIG. 8 shows a side view of the transport arm illustrated in FIG. 7;

FIG. 9 shows the schematic illustration of an embodiment of a vacuum control device;

FIGS. 10a) and 10b) show schematic illustrations of a transport arm, which is rotatable about it longitudinal axis, in plan from above and below.

### DESCRIPTION OF PREFERRED EMBODIMENTS

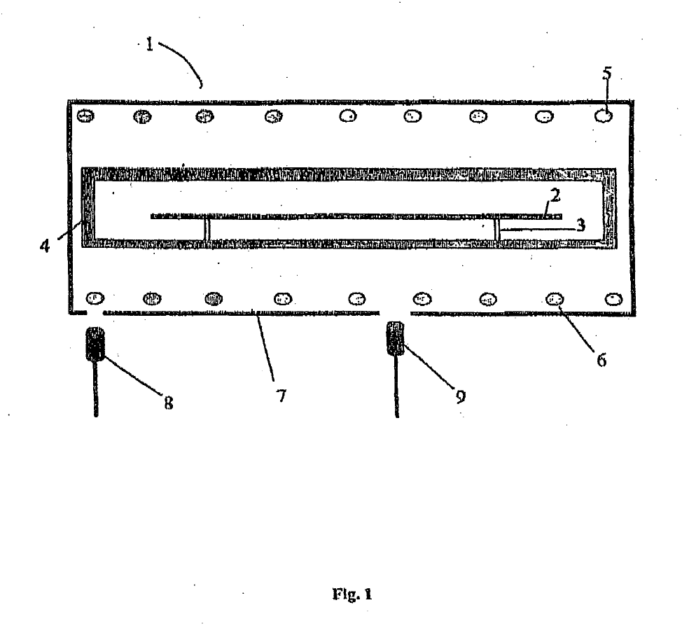

FIG. 1 schematically shows a typical unit 1 for the rapid thermal treatment of objects, preferably disk-shaped semiconductor wafers 2. The wafer 2 is placed upon a holding or support device 3 which can, for example, be pin-shaped support elements or a device upon which the wafer is peripherally disposed, or some other type of wafer support. The wafers 2, including the support device 3, are disposed in the interior of a process chamber 4. The process chamber 4 is a transparent chamber that is preferably manufactured at least in part of transparent quarts. Not indicated are inlets and outlets for process gases by means of which a gas atmosphere that is suitable for the process can be produced. Mounted above and/or below and/or to the side—the latter not being indicated here—of the process chamber 4 are banks of lamps 5 and 6. These are preferably a plurality rod-shaped tungsten-halogen lamps that are disposed parallel to one another; However, other lamps could also be utilized. Alternative embodiments of the chamber eliminate either the upper bank of lamps 5 or the lower bank of lamps 6 and/or the laterally disposed lamps. By means of the electromagnetic radiation emitted from the lamps, the object 2, for example a wafer, is heated. The entire arrangement can be surrounded by an external furnace chamber 7, the inside of the walls of which can be at least partially provided with a reflective surface, and they can preferably be made of a metal such as steel or aluminum. Finally also present is a measurement device, which preferably comprises two non-contact measurement devices 8 and 9. The measurement devices 8 and 9 are preferably two pyrometers; however, CCD monitors or sensors, or other devices for registering radiation, can also be used.

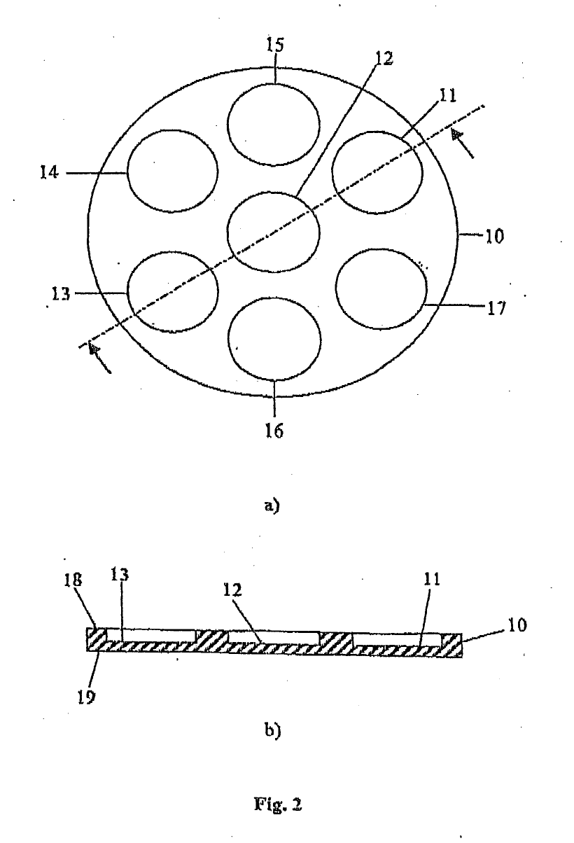

In order to be able to successfully thermally treat connecting of combination semiconductors in such a unit, the semiconductors must be enclosed in a container in order to counteract a decomposition of the semiconductor material. FIG. 2a) illustrates in plan a preferred round disk-shaped carrier 10. FIG. 2b) shows a cross-section through the carrier 10 along the dot-dash line in FIG. 2a).

The carrier 10 has a plurality of circular recesses 11 to 17 of the same diameter in an upper disk surface 18 for respectively receiving a wafer. However, different diameters for the recesses are also possible. In this connection, one recess 12 is centrally disposed in the carrier 10, while the remaining six recesses 11, 13, 14, 15, 16 and 17 surround the central recess 12 along a circle that is concentric to the central recess 12 and to the edge of the carrier. The diameter of the carrier 10 is preferably 200 mm, and the diameter of the same size recesses is preferably 52 mm.

The carrier 10 is preferably made of graphite, sapphire, quartz, boron nitride, aluminum nitride, silicon, silicon carbide, silicon nitride, ceramic or metal. The upper side 18, as well as the underside 19 of the carrier, are advantageously finely blasted with glass beads in order to ensure an optical homogeneity on the upper side 18 and on the underside 19.

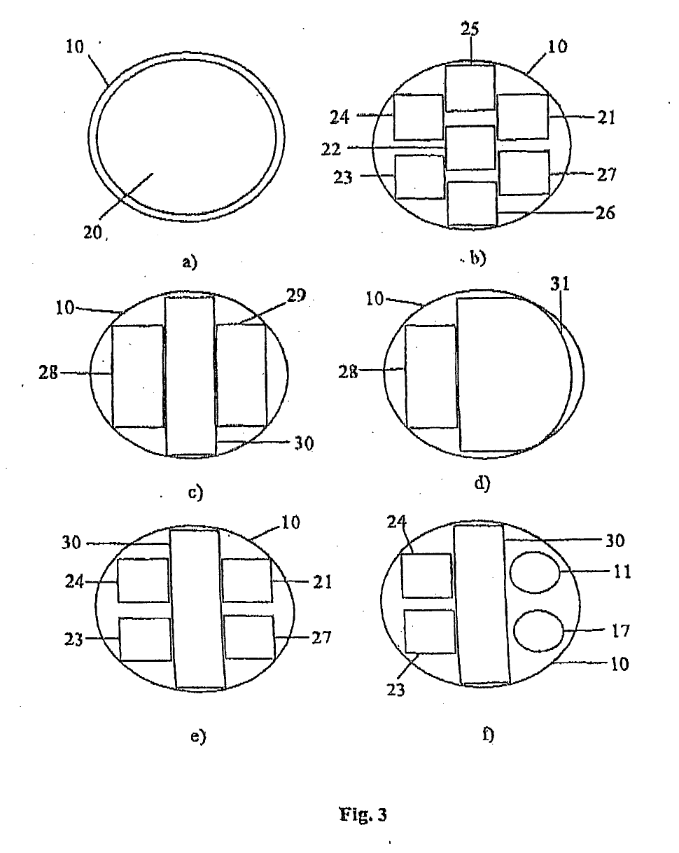

To obtain closed containers or receptacles for the wafers 2 deposited in the recesses 11 to 17, the latter are provided with at least one cover, which can also be finely blasted with glass beads. In FIG. 3a), all of the recesses 11 to 17, with the wafers contained therein, are covered by means of a large cover 20. In another preferred form of the cover shown in FIG. 3b), the recesses 11 to 17 are individually provided with covers 21 to 27. In FIG. 3c) the recesses 14 and 13 are covered by the cover 28, the recesses 11 and 17 are covered by the cover 29, and the recesses 15, 12 and 16 are covered by the cover 30. FIG. 3b) shows an alternative form of the cover, where one of the covers can simultaneously cover an arbitrary member of recesses, however more than one and not all of them. Here the recesses 15, 12, 16, 11 and 17 are covered by the cover 31, and the recesses 14 and 13 are covered by the cover 28. In FIG. 3e), a cover for several recesses is combined with individual covers, with the recesses 15, 12 and 16 being covered by the cover 30, while the recesses 14, 13, 11 and 17 are covered by the corresponding covers 24, 23, 21 and 27. FIG. 3f) finally shows a combination of individual covers, covers for a plurality of recesses, and non-covered recesses. Thus, as in FIG. 3e), the recesses 15, 12 and 16 are covered by one cover 30, the recesses 14 and 13 are covered by the corresponding individual covers 24 and 23, while the recesses 11 and 17 remain uncovered. In general, covers for any number of recesses can be combined in any desired manner with individual covers as well as with non-covered recesses.

The covers are not limited to an upper surface 18 of the carrier 10, and can project laterally beyond the cover 10.

As with the cover 10, at least one of the covers shown in FIGS. 3a to 3f can be made of graphite, sapphire, quartz, boron nitride, aluminum nitride, silicon, silicon carbide, silicon nitride, ceramic or metal. However, not only the carrier 10 but also at least one of the covers can also be made of the aforementioned materials.

For RTP processes, one advantageously selects carriers 10 having at least one cover that has a low specific thermal capacity of the carrier and/or of at least one cover. The thermal capacity is preferably between 0.8 J/gK and 0.2 J/gK. For this reason, the carrier 10 should have as small a thickness as possible that does not exceed 5 mm. A carrier thickness of up to 3 mm is preferred.

Similarly, carriers 10 having at least one cover are advantageous where the carrier 10 and/or at least one of the covers has a high thermal conductivity. The thermal conductivity is preferably between 10 W/mK and 180 W/mK.

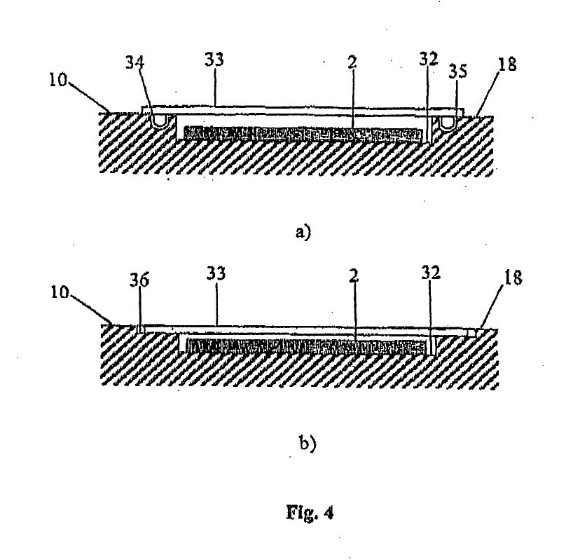

The covers can, as the cover 33 shown in FIG. 4a), be placed upon the carrier 10 and cover the recess 32 with the wafer 2 disposed therein. The cover 33 is preferably provided with knob-shaped formations 34 or similar corresponding devices that fit precisely in corresponding depressions 35 on the upper surface 18 of the carrier 10 and fix the cover 33 in place to prevent it from slipping. However, such devices can also be dispensed with.

Preferred is an embodiment where the recess 32, as shown in FIG. 4b), is provided with an indentation 36 that surrounds it in the manner of a ring and in which the cover 33 is accommodated. The depth of the indentation 36 is advantageously the same as the thickness of the cover 33 in order to provide a flushness with the upper surface 18 and to ensure a planar upper surface of the carrier 10. At least portions of the carrier 10, or portions of one of the covers 20 to 31, or portions of the carrier 10 and portions of at least one of the covers 20 to 31, are advantageously coated. Thus, for example, it can be advantageous to provide an inner surface of one or of all of the recesses 11 to 16, as well as a surface of one or more covers 20 to 31 that cover the recess, at least partially with a specific layer that is inert to chemical processes that occur while processing the wafer 2 within the covered recess 11 to 16, while external surfaces of the carrier 10 remain uncoated in order to exhibit desired absorption characteristics relative to the heat radiation. In other cases, for example local optical characteristics of the carrier 10 and the covers 20 to 31 can be achieved by suitable coating of regions of the outer surfaces.

Similarly, it can be advantageous if at least portions of the carrier 10, or portions of one of the covers 20 to 31, or portions of the carrier 10 and portions of one of the covers 20 to 31, are transparent for the heat radiation by making them, for example, of quartz or sapphire. The covers 20 to 31 as well as parts of the carrier 10 that correspond to the base surfaces of the recesses, are advantageously non-transparent for the heat radiation, while the other parts of the carrier 10 are transparent.

In a preferred embodiment of the carrier 10, all of the recesses 20 to 31 have the same depth. In this way the loaded wafers 2 have a parallel orientation and are all in one plane and at the same height.

However, it can sometimes also be advantageous for the depths of the recesses 20 to 31 to differ. In this case, although the wafers 2 are always still parallel, they are offset from one another in height and are disposed at various planes.

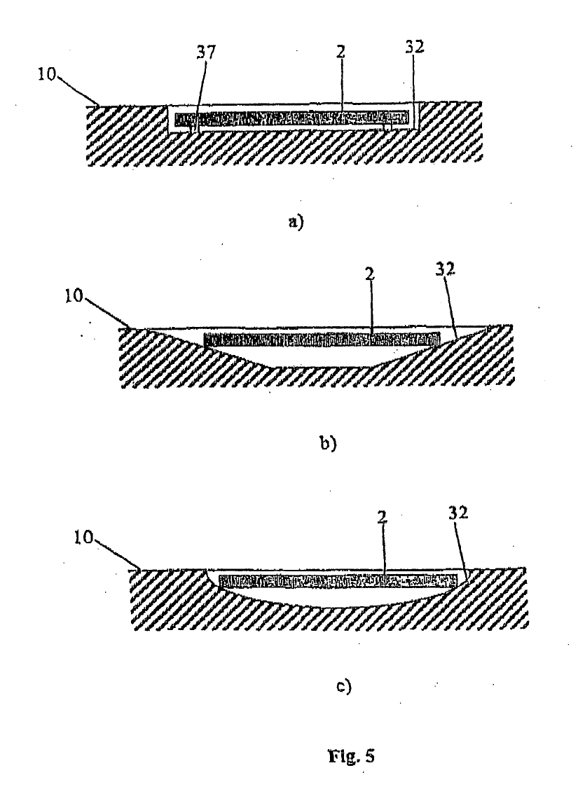

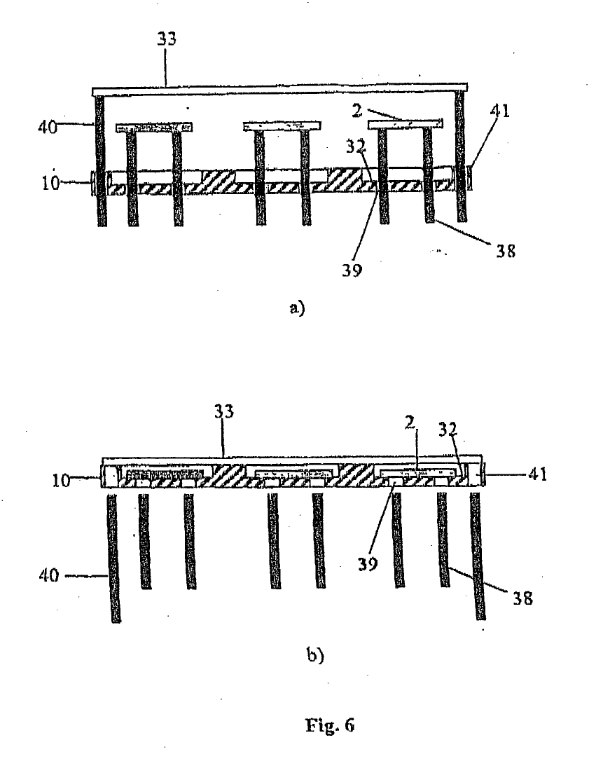

A support of the wafers 2 is advantageously selected within at least one of the recesses 11 to 17 to avoid a contact between the wafer and the base of the recess. As shown in FIG. 5a), this is advantageously achieved by pin-shaped support elements 37 that are disposed within a recess 32 and by which the wafer 2 is accommodated. With recesses having the same depth but with different lengths of support elements 37, the wafers 2 can then be disposed at different planes in each recess.

FIG. 5b) shows another preferred possibility for disposing the wafer 2 in such a way that a contact with a base of the recess 32 is avoided. Here the wafer 2 is supported in its rim region in that the recess 32 tapers conically inwardly. In this way there is achieved an inwardly beveled edge of the recess 32 that enables a rim support of the wafer. With another embodiment shown in FIG. 5c), a recess 32 is concavely configured, which again leads to a supporting of the rim of the wafer 2 upon the edge of the recess 32. Depending upon the design of the conical and of the concave recesses 32, one can place the wafers at different heights.

To load the carrier 10, a gripper is utilized that operates, for example, via a suction device, for example according to the Bernoulli principle. This gripper successively receives the wafers 2 and places them into the recesses 11 to 17.

Pursuant to another embodiment, the wafers 2 are placed upon support pins 38, as shown in FIG. 6a). The support pins 38 are guided through bores 39 that are provided in the base of each recess 32. Similarly, the covers 33 can be disposed on support pins 40. The support pins 40 are either guided through the bores 41, as illustrated in FIG. 6a) and that extend through the carrier 10 beyond the recesses 32, or the support pins 42 extend entirely externally of the carrier 10. The support pins 38 advantageously have different heights for different recesses in order not to hinder a loading of the recesses that are remote from the gripper by the support pins that are provided for loading the recesses that face the gripper. For the same reasons, the support pins 40 for the covers 33 can have different lengths. The support pins 40 are preferably all higher than are the support pins 38.

Pursuant to another embodiment, the carrier 10 is rotated about a vertical axis for the loading. In this way, the recess 32 that is to be loaded at any given time can always face the gripper.

As soon as the wafers 2 are placed upon the support pins 38, and the covers 33 are placed upon the support pins 40, these pins are moved downwardly through the carrier 10, as a result of which the wafers 10 are raised from the support pins 38, and the covers 33 are raised from the support pins 40. The wafers 2 are thereby placed into the recesses associated with them. Alternatively, the carrier 10 can also be moved upwardly.

The loading of the carrier 10 can be effected not only within the process chamber 4, but also externally of the process chamber 4.

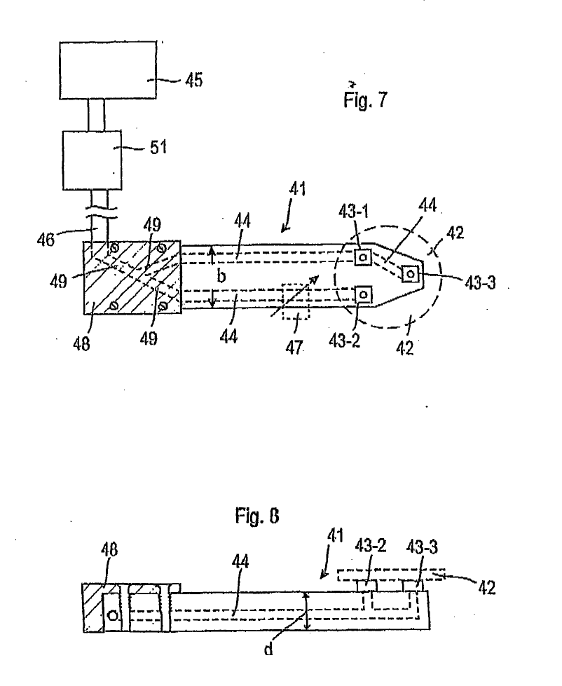

The transport arm 41, which is illustrated in FIGS. 7 and 8, of the inventive handling apparatus, as is used, for example, in conjunction with the handling of wafers and receptacles during thermal treatment processes, typically has a width b of approximately 35 mm, which is less than the diameter of an object, for example a wafer 42 or a receptacle, that is illustrated in dashed lines. In this way, the wafer, which is stacked and accommodated in cassettes such that it is spaced from adjacent wafers, can be removed from the cassettes and after the processing can again be placed therein. The thickness d (see FIG. 8) of the transport arm 41 is in the range of 1 to 5 mm, and is typically 2 mm. The thickness is such that the transport arm 41 fits between two adjacent wafers that are disposed in the cassettes, and can hence remove a wafer 42 from the cassette. The length of the transport arm 41 is selected in conformity with the requirements, and the same is true with the cross-sectional and thickness profile. The typical length of a transport arm 41 in the aforementioned embodiment is between 20 and 70 cm.

Pursuant to the embodiment illustrated in FIGS. 7 and 8, the wafer is supported by three support devices 43-1, 43-2, 43-3, which are also known as pads, and which in the illustrated embodiment are also provided for the support of a (not-illustrated) receptacle. Alternatively, it is also possible to provide different support devices or pads for the wafers on the one hand and the receptacle on the other hand.

Provided in the transport arm 41 are vacuum or underpressure lines 44 that connect the pads 43-1, 43-2, 43-3 with a vacuum or underpressure source 45 via a connecting line 46. Provided in one vacuum line 44 to one of the pads 43-2 is a vacuum control element 47, for example a controllable valve.

The transport arm 41 is connected via a securement element 48 with non-illustrated components and movement elements of the handling device. Similarly extending in the securement element 48 are vacuum lines or channels 49, those ends of which face away from the transport arm being connected to the connecting line 46.

As already described previously in detail, the pads 43-1, 43-2, and 43-3 can have shapes, masses and designs that are adapted in conformity to the conditions in order to reliably support the wafer as well as the receptacle that is to be handled.

Pursuant to a further embodiment of the invention, the vacuum control element 47 is adapted to apply a vacuum to one of the pads that differs from that applied to the remaining pads, if this is necessary.

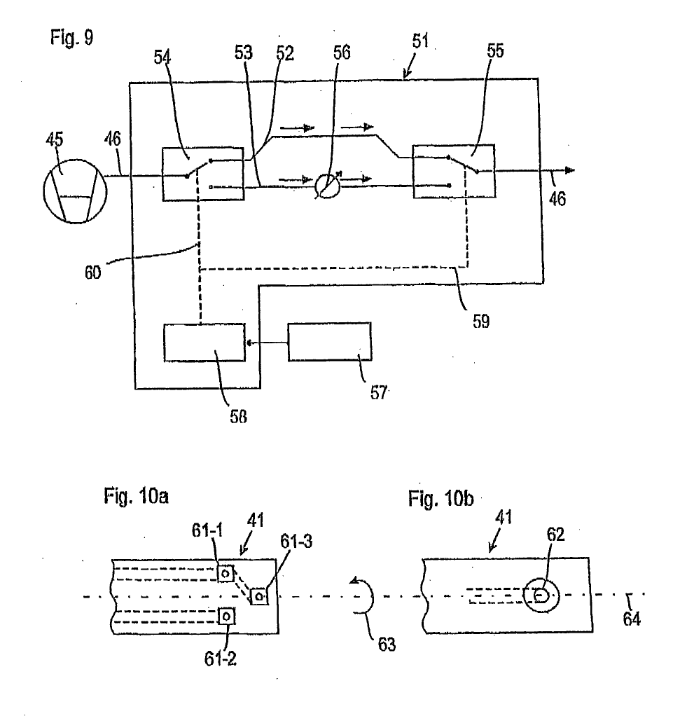

In addition, individual vacuum control elements can be respectively provided for each of the pads. A vacuum control device 51 can be provided in the connecting line 46, for example between the transport arm 41 and the underpressure or vacuum source 45. One embodiment for this is schematically illustrated in FIG. 9. In the connecting line 46, between the vacuum source 45 and the vacuum lines 44 of the transport arm 41, two parallel vacuum lines 52 and 53 are provided in the vacuum control device 51 and can be selectively switched into the vacuum line 46 via a first and a second change-over switch 54, 55. The first vacuum line 52 serves for conveying the vacuum made available from the vacuum source 45 without change to the vacuum lines 44 of the transport arm 41. In contrast, provided in the second vacuum line 53 of the vacuum control device 51 is a vacuum regulator 56 that alters the vacuum in the second connecting line 53.

In the illustrated embodiment the switching of the change-over switches 54 and 55 is effected via a computer that is controlled by instruction software and is schematically provided with the reference numeral 57 and makes available to an interface 58 of the vacuum control device 51 the appropriate program instructions, which then pass in the form of control signals to the change-over switches 54 and 55 via electrical lines 59 and 60.

Instead of controlling the change-over switches 54 and 55 by means of a program, it is also possible to control the switching of the output signal of the weight sensor that detects the weight of the object that is to be handled.

With an object 42 that is to be handled that has a relatively high weight, a relatively high vacuum, i.e. a relatively small absolute pressure, is applied to the support devices 43-1, 43-2, 43-3 in that the first vacuum line 52, which does not have a vacuum regulator, is connected with the vacuum source 45 via the switch position of the change-over switches 54 and 55 illustrated in FIG. 9. In the case of the temperature treatment of wafers, this object—as previously described in detail—is a receptacle in which at least one wafer is contained, and which, for example, is made of graphite, silicon carbide or aluminum nitride.

Such a receptacle of graphite can, pursuant to further embodiments, also be coated with the materials silicon carbide or aluminum nitride. Due to the relatively high vacuum, the receptacle is securely and reliably pressed against and held on the support device via the pads 43-1, 43-2, 43-3 during the handling and transport process.

If, however, with the same handling apparatus an object having a lesser weight, for example a semiconductor wafer having a weight of 0.1 to 20 g, is to be transported or handled, the change-over switches 54 and 55 are switched over into the position in which the pads 43-1, 43-2, and 43-3 communicate with the pressure source 45 via the second connecting line 53. In this second connecting line 53, the vacuum is reduced by the vacuum regulator 56, in other words the absolute pressure is increased, so that the application pressure is less for the wafer than for the receptacle. This vacuum is thus adapted to the wafer and is so low that the danger of breakage due to too great of a vacuum at the pads is prevented.

In FIGS. 10a and 10b an embodiment is illustrated for a transport arm 41 that has a respective support apparatus on both sides that can differ from one another, for example, with regard to the number of pads 61-1, 61-2, 61-3, 62, the structure thereof, the form thereof and/or the dimensions thereof. Whereas in FIG. 10a a pad structure is illustrated that essentially corresponds to the embodiment of FIG. 7, and is provided for supporting objects having little weight, for example wafers, the other side of the transport arm 41 has a pad structure that, for example, has only one relatively large surfaced, round pad that is connected to only one vacuum line and is provided, for example, for an object having a high weight, for example for a wafer receptacle or a graphite box.

As indicated by the arrow of rotation 63, with this embodiment the transport arm 41 can be rotated about its axis 64 by 180°, so that depending upon whether the object with great weight or the object with lesser weight is to be supported and handled, one of the two side of the transport arm 41 can be selectively used.

If the handling apparatus is used in the semiconductor industry, the material thereof, and in particular the material of the transport arm 41, should be suitable for this application, and preferably comprises sapphire, ceramic and/or quartz, of a combination of these materials. These materials furthermore have the advantage that the loading and unloading of a process chamber can be effected at temperatures of up to 700° C. Due to the high modulus of elasticity, sapphire and ceramic also have the further advantage of a high rigidity, i.e. the transport arm 41, even if a receptacle having a weight of 200 g is placed thereupon, bends or bows only slightly, if at all. The surface of the transport arm 41 should be as smooth as possible. This, and as unitary a design of the transport arm 41 as possible, facilitates the cleaning and reduces a possible transport of particles into the process chamber.

Although the invention was described with the aid of preferred embodiments, it is not limited to the concrete embodiments. For example, the carrier 10 can have an angled shape. Similarly, the recesses can have an angular shape. In addition, the number of recesses is not limited to seven. Also with carriers having round recesses the diameter of the recesses can differ from 52 mm in order to also be able to accommodate wafers of 100 mm or 150 mm. A carrier can, for example, also have recesses having different dimensions. Furthermore, individual features of the above described embodiments can be combined or exchanged with one another in any compatible manner.

The inventive handling apparatus is also not limited to the features and design of the described embodiments. For example it is also possible to support the objects, for example, the wafers or receptacles, on the support devices in such a way that the suction is effected via the Bernoulli effect, in other words, in that vacuum is supplied to the holding devices or pads, so that a Bernoulli effect results. In this case, acceleration forces in the horizontal direction must be provided via additional auxiliary means, which, for example, can be edge boundaries via which the objects can be fixed in position relative to the transport arm 41.

This specification incorporates by reference the disclosure of German priority documents 101 24 647.1 filed May 18, 2001 and 101 56 441.4 filed Nov. 16, 2001 as well as PCT/EP02/04790 filed May 2, 2002.

The present invention is, of course, in no way restricted to the specific disclosure of the specification and drawings, but also encompasses any modifications within the scope of the appended claims.

1-51. (canceled)

52. A device for accommodating disk-shaped objects, for a thermal treatment thereof, comprising:
a carrier having at least two recesses respectively receiving an object; and
at least one recess cover, wherein said at least one recess cover closely covers at least one of said recesses.

53. A device according to claim 52, wherein at least one of said carrier and at least one of said at least one cover are made of graphite, sapphire, quartz, boron nitride, aluminum nitride, silicon, silicon carbide, silicon nitride, ceramic and/or metal.

54. A device according to claim 52, wherein at least one of said carrier and said at least one cover have a thermal capacity between 0.2 J/gK and 0.8 J/gK.

55. A device according to claim 52, wherein at least one of said carrier and said at least one cover have a thermal conductivity of between 10 W/mK and 180 W/mK.

56. A device according to claim 52, wherein at least portions of at least one of said carrier and said at least one cover are coated.

57. A device according to claim 52, wherein at least portions of at least one of said carrier and said at least one cover are transparent.

58. A device according to claim 52, wherein gas atmospheres that differ from one another are provided in individual ones of said recesses.

59. A device according to claim 52, wherein said objects are disposed in one plane.

60. A device according to claim 52, wherein said objects are disposed in at least two planes that are parallel to one another and are spaced from one another.

61. A device according to claim 60, wherein at least two recesses have different depths.

62. A device according to claim 52, wherein at least one object rests flat upon a base surface of its recess.

63. A device according to claim 52, wherein at least one object is spaced from the base surface of its recess.

64. A device according to claim 63, wherein support elements are provided for supporting at least one object.

65. A device according to claim 63, wherein at least one object rests upon its rim region.

66. A device according to claim 52, wherein at least one recess has a conical configuration in at least its outer region.

67. A device according to claim 52, wherein at least one recess has a concave configuration.

68. A device according to 52, wherein at least two recesses have different dimensions.

69. A device according to claim 52, wherein at least two of the objects have different dimensions.

70. A device according to claim 52, wherein said objects are compound semiconductors.

71. A device according to claim 52, wherein at least two of the objects have different materials.

72. A device according to claim 52, wherein said objects are at least partially coated.

73. A device according to claim 52, wherein the material of said object is non-homogenous.

74. A device according to claim 52, wherein said first and second support pins pass through said carrier.

75. A device according to claim 52, wherein said first support pins have different heights than the second support pins.

76. A device according to claim 52, wherein those support pins provided for said covers are higher than those provided for said objects.

77. A device according to claim 52, wherein at least one support pin for said covers is provided externally of the carrier.

78. A device according to claim 52, wherein said first and second support pins are moveable 5 relative to the carrier in the vertical direction.

79. A device according to claim 78, wherein said first and second support pins are movable vertically downwardly for a placement of said objects into said recesses and/or for a placement of said covers upon said carrier.

80. A device according to claim 78, wherein the first support pins are movable vertically upwardly for a raising of said objects out of said recesses and wherein said second support pins are movable vertically for a raising of said covers from said carrier.

81. A device according to claim 78, wherein said carrier is movable vertically.

82. A device according to claim 52, wherein a gripper is provided that has suction devices for a deposit of said objects into said recesses and/or upon said support pins, and/or for a removal of said objects from said recesses and/or from said support pins.

83. A device according to claim 52, wherein a rotary device is provided for a rotation of said carrier about a vertical axis.

84. A device according to claim 52, wherein said carrier is adapted to be loaded within a process chamber or externally of a process chamber.

85. A device according to claim 52, wherein an automatic loading and unloading device is provided.

86. A handling device, comprising:
at least one transport arm;
at least one support device provided on said at least one transport arm, for supporting via vacuum at least one object that is to be handled;
means for determining the individual weight of an object that is to be handled; and
a vacuum control device for altering the vacuum as a function of the weight of the object.

87. A handling apparatus according to claim 86, wherein said vacuum control device includes a vacuum source and vacuum change-over devices.

88. A handling apparatus according to claim 87, wherein said vacuum change-over devices are provided with switches for a changing-over between lines with and without vacuum regulators.

89. A handling apparatus according to one of the claim 86, wherein said vacuum control device has at least two separate vacuum systems.

90. A handling apparatus according to claim 86, wherein a vacuum ratio for the objects that are to be handled and that have different weights is in a range of from 10 to 10,000.

91. A handling apparatus according to claim 86, wherein at least two transport arms are provided, at least one of which is provided for supporting objects of greater weight, and at least one further arm is provided for supporting objects of lesser weight.

92. A handling apparatus according to claim 86, wherein said at least one support device is differently embodied for different objects.

93. A handling apparatus according to claim 86, wherein said at least one support device is a three-point support device.

94. A handling apparatus according to claim 86, wherein support devices are provided on opposite sides of the transport arm.

95. A handling device according to claim 94, wherein one side of said transport arm is provided with at least one support device for an object of greater weight, and the other side of said transport arm is provided with at least one support device for an object of lesser weight.

96. A handling apparatus according to claim 94, wherein said transport arm is rotatable about 180° relative to its longitudinal axis.

97. A handling apparatus according to claim 91, wherein a semiconductor wafer is an object of lesser weight and wherein a semiconductor wafer receptacle is an object of greater weight.

98. A handling apparatus according to claim 86, wherein said vacuum control device is controllable as a function of a prescribed program sequence.

99. A handling apparatus according to claim 86, wherein a sensor is provided for measuring the weight of an object that is to be handled, and wherein an output signal of said sensor serves for control of said vacuum control device.

100. A device for accommodating disk-shaped objects, for a thermal treatment thereof, comprising:
a carrier having at least two recesses respectively receiving an object;
at least one recess cover, wherein said at least one recess cover closely covers at least one of said recesses;
first support pins for a loading of at least one of said objects; and
second support pins for loading said at least one recess cover on said carrier.
